(19) United States
(12) Patent Application Publication
(10) Pub. No.: US 2024/0145737 A1
(43) Pub. Date: May 2, 2024

(54) SEPARATOR PLATE FOR AN ELECTROCHEMICAL SYSTEM, HAVING A SHOCK ABSORBER ARRANGEMENT

(71) Applicant: Reinz-Dichtungs-GmbH, Neu-Ulm (DE)

(72) Inventors: Bernd GAUGLER, Ulm (DE); André SPEIDEL, Bussmanshausen (DE); Stephan WENZEL, Pfaffenhofen (DE)

(21) Appl. No.: 18/496,714

(22) Filed: Oct. 27, 2023

(30) Foreign Application Priority Data
Oct. 28, 2022 (DE) 20 2022 106 078.9

(51) Int. Cl. H01M 8/0273; H01M 8/0254; H01M 8/18; H01M 8/2475

(52) U.S. Cl. CPC H01M 8/0273; H01M 8/0254; H01M 8/188; H01M 8/2475

(57) ABSTRACT

A separator plate for an electrochemical system. The separator plate having a shock absorber arrangement. A bipolar plate comprising two separator plates for an electrochemical system, each having a shock absorber arrangement. An electrochemical cell comprising two separator plates for an electrochemical system, each having a shock absorber arrangement. An assembly for an electrochemical system, comprising at least one separator plate and a membrane electrode assembly (MEA). The electrochemical system may be a fuel cell system, an electrochemical compressor, a redox flow battery, or an electrolyser.

### CROSS-REFERENCE TO RELATED APPLICATION

The present application claims priority to German Utility Model Application No. 20 2022 106 078.9, entitled, “SEPARATOR PLATE FOR AN ELECTROCHEMICAL SYSTEM, HAVING A SHOCK ABSORBER ARRANGEMENT”, and filed Oct. 28, 2022. The entire contents of the above-listed application is hereby incorporated by reference for all purposes.

### TECHNICAL FIELD

The present disclosure relates to a separator plate for an electrochemical system, said separator plate having a shock absorber arrangement, to a bipolar plate comprising two separator plates for an electrochemical system, each having a shock absorber arrangement, and to an electrochemical cell comprising two separator plates for an electrochemical system, each having a shock absorber arrangement. The present disclosure additionally relates to an assembly for an electrochemical system, comprising at least one separator plate and a membrane electrode assembly (MEA). The electrochemical system may be a fuel cell system, an electrochemical compressor, a redox flow battery, or an electrolyser.

### BACKGROUND AND SUMMARY

Known electrochemical systems usually comprise a stack of electrochemical cells which are separated from each other by bipolar plates. Dimensionally stable and structurally rigid end plates are usually arranged at both ends of the stack. Such bipolar plates may serve, for example, for indirectly electrically contacting the electrodes of the individual electrochemical cells (for example fuel cells) and/or for electrically connecting adjacent cells (series connection of the cells). The bipolar plates are typically formed of two individual plates which are joined together, these being referred to hereinafter as separator plates. The separator plates of the bipolar plate may be joined together in a materially bonded manner, for example by one or more welded joints, for example by one or more laser-welded joints. While bipolar plates composed of two separator plates are almost always used in fuel cell systems, either two-layer bipolar plates or single-layer separator plates instead of bipolar plates may be used in the other electrochemical systems mentioned.

The bipolar plates or the individual separator plates may each have or form structures which are designed, for example, to supply one or more media to the electrochemical cells bounded by adjacent bipolar plates and/or to convey reaction products away therefrom. The media may be fuels (for example hydrogen or methanol) or reaction gases (for example air or oxygen). The bipolar plates or the separator plates may also have structures for passing a cooling medium through the bipolar plate, such as through a cavity enclosed by the separator plates of the bipolar plate. The bipolar plates may additionally be designed to transfer the waste heat generated during the conversion of electrical or chemical energy in the electrochemical cell and to seal off the different media channels and/or cooling channels with respect to each other and/or with respect to the outside.

Furthermore, the bipolar plates usually each have a plurality of through-openings. Through the through-openings, the media and/or the reaction products can be fed to the electrochemical cells bounded by adjacent bipolar plates of the stack, or into the cavity formed by the separator plates of the bipolar plate, or can be discharged from the cells or from the cavity. The electrochemical cells typically also each comprise one or more membrane electrode assemblies (MEAs), The MEAs may have one or more gas diffusion layers, which are usually oriented towards the bipolar plates and are formed, for example, as a metal or carbon fleece.

The sealing between the bipolar plates and the membrane electrode assembly usually takes place by way of sealing elements arranged outside of the electrochemically active region and usually comprises both at least one port seal arranged around a through-opening and also an outer seal (perimeter sealing element), it being possible for the sealing elements to be designed as bead arrangements.

In order for the sealing elements to be able to achieve a consistently good sealing effect regardless of the respectively prevailing operating state, it is desirable that the sealing elements may be elastically deformable, e.g. reversibly deformable, at least within a specified tolerance range. However, if the sealing elements are deformed beyond the tolerance range, plastic deformations, e.g. irreversible deformations, of the sealing elements may occur. This may lead to the sealing elements no longer being able to fulfil their sealing effect. This can significantly reduce the efficiency of the system or even make it completely impossible to maintain operation of the system. If the system is operated with highly flammable media, such as hydrogen for example, or if such media are produced during operation, damage to the sealing elements may even pose a major safety risk. Irreversible deformation of the sealing elements of the bipolar plates or separator plates may be caused, for example, by the sudden effect of large mechanical forces on the plate stack, as may occur in the case of a car crash for example.

When such an electrochemical cell is subjected to a force impact, for example due to a collision, the sealing elements may sometimes undergo considerable deformations. Due to the inertia of the components and of the media guided therein, especially the coolant, during the collision, an excessive force occurs on the sealing elements of the bipolar plates in the direction of impact. This force may lead to permanent deformation of the sealing elements. During the actual collision, the forces may act strongly on the sealing elements of the bipolar plates which are located at a short distance from the force application point and are thus arranged closer to the end plate referred to as the first end plate. As the distance of the bipolar plates increases, the force exerted on the sealing elements at the time of the collision decreases. As the stack subsequently “rebounds”, the sealing elements of the bipolar plates on the side remote from the impact, to which no force is applied, are abruptly compressed as a result of striking against the second end plate, the forces here being greater as the distance of the bipolar plates from the site of impact increases. Both phenomena, which are comparable to a shock wave, may lead to a loss of sealing of the stack as a whole and may thus render it unusable.

Therefore, a system is provided with a protective mechanism which protects the sealing elements as much as possible from irreversible plastic deformations, even when large mechanical forces are applied.

One known solution provides for enclosing the electrochemical system in a protective container which has a high strength and good mechanical stability. However, in the event of an impact, an impulse transfer may occur which is so large that it cannot be absorbed and/or eliminated by the protective container; it is therefore transmitted to the plate stack in substantially unattenuated form. Furthermore, such a protective container is usually associated with additional costs, weight, installation space requirements and outlay on material, which are often undesirable, especially for mobile applications.

Other known solutions provide electronic switch-off mechanisms, but these merely interrupt flows of media and do not provide any protection against mechanical destruction.

It would therefore be desirable if an assembly could be created that can withstand the greatest possible mechanical loads and thus ensures the safest possible operation. The installation space requirement and the weight of the assembly sought should increase as little as possible or barely at all compared to the known solutions.

WO 2019/076813 A1 proposes pad-like shock absorbers for absorbing the impact energy, which are applied in the border region of the bipolar plate, for example by being placed or plugged thereon or adhesively bonded thereto. The application of these shock absorbers is therefore associated with additional effort and often with at least one additional manufacturing step. It would be desirable if production of the separator plate could be simplified.

The object of the present disclosure is therefore to develop a more robust separator plate, and an assembly or an electrochemical cell comprising at least one separator plate, which at least partially solves the problems mentioned above.

The object is achieved by the subjects of the independent claims.

A separator plate according to the present disclosure for an electrochemical system has at least one edge which bounds the separator plate laterally in a direction parallel to a flat surface plane of the separator plate. Furthermore, the separator plate has a bead arrangement which extends at a distance from the edge at least in part around a region to be sealed off and projects upwards out of the flat surface plane. The separator plate additionally has at least in part along the edge at least one shock absorber arrangement which is arranged at a distance from the bead arrangement, wherein the edge in the region of the shock absorber arrangement extends upwards at a distance from the flat surface plane so that the shock absorber arrangement projects upwards out of the flat surface plane.

The shock absorber arrangement is designed in such a way that the shock absorber arrangement projects further out of the flat surface plane than the bead arrangement in a non-compressed state of the separator plate. The non-compressed state is characterized in that no external mechanical forces act on the separator plate. The non-compressed state may be characterized by the absence of forces that cause deformation of the separator plate. Mechanical forces resulting from the intrinsic weight of the separator plate can be disregarded here. For example, the separator plate may be in a non-compressed state at a point in time following production thereof and prior to being compressed in a stack of an electrochemical system. When the separator plate is joined together with a further separator plate to form a bipolar plate, the resulting bipolar plate is likewise in a non-compressed state before being inserted and compressed in the stack.

In this case, the fact that the shock absorber arrangement projects further out of the flat surface plane than the bead arrangement means that the shock absorber arrangement projects further upwards out of the flat surface plane than the bead arrangement. This may mean that a maximum height, measured perpendicular to the flat surface plane, of the shock absorber arrangement is greater than a maximum height of the head arrangement. For instance, it may mean that the shock absorber arrangement is the structure of the separator plate that projects furthest out of the flat surface plane among all the embossed or applied structures of the separator plate. This may also mean that the separator plate has in the region of the shock absorber arrangement its largest extent perpendicular to the flat surface plane of the separator plate.

By virtue of the separator plate described above, forces that may occur in the event of an impact, for example, can be absorbed by the shock absorber arrangement and thus better distributed or diverted away from the bead arrangement. Since the shock absorber arrangement typically forms the highest structure of the separator plate, or in any case is higher than the bead arrangement, the shock absorber arrangement will be most strongly deflected out of its starting position when the separator plate is compressed in a stack. In the event of a crash, such a pretensioned shock absorber arrangement can absorb this additional force, which without such pretensioning would have to be absorbed by the bead, and thus relieves the load on the bead arrangement, as a result of which the likelihood of permanent deformation of the bead arrangement can be reduced.

The separator plate may be formed from a sheet, such as a metal sheet. The bead arrangements and/or the shock absorber arrangements of the separator plate may be integrally formed in the respective individual plate, for example by means of hydroforming, embossing and/or deep-drawing. In this specification, the term embossing will be used as representative of hydroforming, embossing and deep-drawing. The flat surface plane of the separator plate may be a plane spanned by three points from undeformed regions of the separator plate. These three points are typically located in the bearing area of the undeformed regions of the separator plate, at which the latter adjoins the next separator plate in the assembled state, e.g. typically on the side facing away from the MEA in the case of a fuel cell. Undeformed regions of the separator plate may be regions of the separator plate that have no embossed structures. The separator plate has a thickness that is usually at least 5 μm and/or at most 200 μm. The thickness is in this case therefore the extent of the sheet of the separator plate perpendicular to the flat surface plane and can in some cases be disregarded compared to the other dimensions of the separator plate.

The regions that bound the separator plate in projection onto the flat surface plane can be regarded as the edge of the separator plate. When the plate thickness is disregarded, the edge itself can be perceived as a line. In some cases, e.g. when the plate thickness is not disregarded, the edge may also be perceived as a surface, wherein the surface that in this case describes the edge may be at an angle, or often perpendicular, to the flat surface plane. At least one edge may be formed, for example, by a lateral border of the separator plate.

The separator plate is bounded by the edge in at least one direction, which is parallel to the flat surface plane. The edge often bounds the separator plate circumferentially, e.g. along multiple directions.

Here, upwards denotes a direction perpendicular to the flat surface plane. A region of the separator plate that projects upwards out of the flat surface plane is therefore arranged at a distance from the flat surface plane.

The bead arrangement may be designed as a full bead. Starting from the flat surface plane, the full bead rises via bead flanks on both sides to the bead top, Bead shapes are possible in which the top is designed as a plateau, e.g. usually extending at a distance from and parallel to the flat surface plate. In this case, angles are spanned between the flat surface plane and the bead flanks, and counter-angles are spanned between the head top and the bead flanks, wherein the angles are greater than 0° and less than 90°, such as between 25 and 60°. However, bead shapes are also possible in which the top is completely curved, e.g. describes an arcuate shape together with the bead flanks. More complex bead shapes are also possible, such as those described for example in DE 10 2009 012 730 A1, DE 10 2009 006 413 A1, DE 102 48 531 A1, DE 20 2022 101 861 (not yet published on the date of filing of the present specification) and DE 20 2014 004 456 U1, the content of each of said specifications being fully incorporated by way of reference in the present specification. A transition between a region extending in the flat surface plane and a flank will sometimes be referred to as a bead base.

In this context, arranged at a distance from the edge means that the bead arrangement does not touch the edge. When it is stated that the shock absorber arrangement is arranged at a distance from the head arrangement, this means that undeformed regions of the separator plate, or at least structures other than the bead arrangement or the shock absorber arrangement, are arranged between the shock absorber arrangement and the bead arrangement. The region enclosed between the edge and the bead arrangement will hereinafter also be referred to as the outer border region.

The fact that the shock absorber arrangement projects upwards out of the flat surface plane may mean that there is no material between the separator plate in the region of the shock absorber arrangement and the flat surface plane. The shock absorber arrangement projects upwards out of the flat surface plane, e.g. in the same direction out of the flat surface plane as the bead arrangement.

In the region of the shock absorber arrangement, and at least in the non-compressed state of the separator plate, a cross-section of the outer border region may have a substantially flat plateau portion and a flank or curvature rising at an angle out of the plate plane, the flank or curvature typically merging into the plateau portion. The width of the plateau portion, e.g. the extent of the plateau in a direction perpendicular to the course of the edge, may vary along the course of the edge. In the region of the shock absorber arrangement, the flank or curvature may be at a different distance from the edge along the course of the edge. The plateau portion belonging to the shock absorber arrangement, which can be perceived as the plateau portion of the sheet that forms the separator plate, said sheet possibly being pre-coated, in many cases projects further out of the flat surface plane than the highest point of the bead arrangement in the non-compressed state of the separator plate.

In one embodiment of a separator plate, the shock absorber arrangement has a deformable absorber coating which projects further out of the flat surface plane than the bead arrangement in the non-compressed state of the separator plate. The deformable coating may be provided along the entire course of the shock absorber arrangement or only in a localized manner. Typically, the absorber coating is applied to the plateau portions mentioned above. The absorber coating may be elastically deformable at least to a certain extent. For instance, the absorber coating may be applied as a partial coating to the metal separator plate material or to a coating already present across the entire surface thereof. This may mean, for example, that the absorber coating is applied from above. By way of example, the absorber coating may be applied in a screen printing process.

Ideally, when energy is introduced into the separator plate, for example in the form of a force impact during a collision, an elastic or largely reversible deformation of the shock absorber arrangement takes place, without the bead arrangement losing its sealing function. This deformation may affect the shock absorber arrangement and/or the shape of the separator plate in the region of the shock absorber arrangement, for example by deflection followed by full rebound. For instance, the absorber coating itself may also be designed in such a way that it absorbs impact energy and, following a force impact, returns to its starting position prior to the force impact. The time taken for the absorber portion, for example the plateau, integrally formed in the plate material to rebound is usually much faster than the time taken for the absorber coating to deform back.

In some embodiments, the points of the shock absorber arrangement that project furthest upwards may form one or more lines. In some embodiments, these line(s) or surface(s), also referred to as ridge line(s) or ridge surface(s), may extend at least in part along the absorber coating.

The shock absorber arrangement projects beyond the bead arrangement by at least 0.05 and/or at most 0.5 mm, at least 0.08 and/or at most 0.4 mm, and/or at least 0.1 and/or at most 0.3 mm.

Embodiments of the separator plate are possible in which the absorber coating and/or the plateau portion forms the region of the separator plate that projects furthest upwards out of the flat surface plane.

In one embodiment of the separator plate, the absorber coating comprises or consists of a polymer and/or a foamed material. Furthermore, the absorber coating may also comprise or consist of two or more coatings, which are arranged for example one on top of the other. In this case, each of the coatings may have different properties, such as, for example, different spring constants or moduli of elasticity and/or different heights. As a result, the spring behaviour of the shock absorber arrangement can be adjusted within certain limits. Optionally, the two coatings may comprise or consist of different materials. Embodiments of the separator plate are also possible in which the absorber coatings comprise coatings arranged side by side. These coatings arranged side by side may comprise or consist of different materials. Furthermore, absorber coatings arranged side by side may merge into each other at least in part and/or may be arranged at a distance from each other at least in part. In this case, side by side means that both coatings are visible in a plan view of the separator plate. The sealing and/or absorber coatings may optionally be single-layer and/or multi-layer coatings.

In optional embodiments of the separator plate, the bead arrangement has a sealing coating which protrudes less far out of the flat surface plane than the shock absorber arrangement in a non-compressed state of the separator plate.

In some embodiments of the separator plate, the sealing coating comprises or consists of a polymer.

In embodiments in which the separator plate has a sealing coating and an absorber coating, it may be provided that the sealing coating and the absorber coating comprise different material compositions or consist of different materials. In some embodiments, the sealing coating and the absorber coating may comprise the same materials or consist of the same materials. In this case, the application of the sealing coating and of the absorber coating may take place in one step, for example in a screen printing process.

It may be provided that the edge comprises an outer edge which hounds an outer circumference of the separator plate, and/or a port edge which bounds a through-opening formed in the separator plate for the passage of a fluid.

The shock absorber arrangement and/or the edge in the region of the shock absorber arrangement may optionally extend at least in part parallel to the flat surface plane of the separator plate. For example, the shock absorber arrangement may have regions which are flat and arranged parallel to the flat surface plane. For instance, a plateau portion of a shock absorber arrangement may extend in part parallel to the flat surface plane of the separator plate.

The shock absorber arrangement may often have stiffening structures which point away from the edge and/or point towards the bead arrangement. In some embodiments, the stiffening structures may extend perpendicular to the edge. The stiffening structures may be designed as a lengthening or shortening of the above-mentioned plateau portion perpendicular to the edge. An extent of the plateau portion perpendicular to the edge may thus depend on the presence of the stiffening structures and/or on the shape and size of the stiffening structures. The flank or curvature may be at a different distance from the edge in the region of the stiffening structures than in an adjoining region without stiffening structures. For example, if the stiffening structures are designed as bulges, the flank/curvature may be at a greater distance from the edge in the region of the bulges. If the stiffening structures are designed as indentations, the flank/curvature may be at a smaller distance from the edge in these regions.

Embodiments are possible in which the stiffening structures do not form the highest region of the shock absorber arrangement. Embodiments are possible in which the stiffening structures have a maximum height that is at most equal to or less than a maximum height of the plateau portion and/or the bead arrangement.

The absorber coating may optionally be arranged on the stiffening structures of the shock absorber arrangement alone or additionally on the plateau portion, such as in a continuous manner.

In one embodiment of the separator plate, the separator plate may have supporting arrangements which are arranged along part of the edge and which project less far upwards out of the flat surface plane of the separator plate than the shock absorber arrangement and/or the bead arrangement in the non-compressed state of the separator plate. Like the shock absorber arrangement, the supporting arrangement may likewise have a flank and a plateau portion that is formed parallel to the flat surface plane. In this regard, a shape of the supporting arrangement may resemble a shape of the shock absorber arrangement. For example, a supporting arrangement may be arranged as a continuation of the shock absorber arrangement in a corner region of a through-opening or of the outer edge.

In a further embodiment of the separator plate, the width of the shock absorber arrangement and/or the maximum distance of the shock absorber arrangement from the flat surface plane and/or the slope of the flank of the shock absorber arrangement in a non-compressed state varies along the course of the shock absorber arrangement. A width can be understood as the extent of the respective structure in a direction perpendicular to the course of the respective structure. Regions of different widths permit different widths of bearing surfaces for a possible absorber coating. The flank of the shock absorber that points towards the bead arrangement, and the slope of this flank, may be varied at the same time as varying the width of the shock absorber, or independently thereof. The same applies to varying the height of the shock absorber. By varying these parameters, the elasticity of the respective structure can be varied. As a result, the force-displacement characteristic of the respective structure can be adjusted, and for example in the case of the bead arrangement can be tailored to the sealing properties of the bead arrangement.

Different embodiments of shock absorber arrangements may be arranged along the course of the edge, and different embodiments of the shock absorber arrangements may also be arranged at different edges.

Furthermore, in some embodiments of the separator plate, the height of the shock absorber arrangement may vary along the course of the shock absorber arrangement. In this case, the ridge line of the shock absorber arrangement, at any point along the course thereof, may be higher than the highest point of the bead arrangement. In addition, embodiments may be possible in whish the height of the bead arrangement varies along the course thereof. In this case, the highest point of the ridge line of the bead arrangement may be lower than the lowest point of the ridge line of the shock absorber arrangement. The width of the bead arrangement, for example a width of the top, a width of the flanks and/or an overall width, may also vary along the course thereof.

Also proposed is an assembly for an electrochemical system, comprising a separator plate. The separator plate has at least one edge which bounds the separator plate laterally in a direction parallel to the flat surface plane of the separator plate. The separator plate also has a bead arrangement which extends at a distance from the edge at least in part around a region to be sealed off and projects upwards out of the flat surface plane. The assembly further comprises a membrane electrode assembly, MEA, and a shock absorber arrangement. The shock absorber arrangement is arranged at least in part along the edge, at a distance from the bead arrangement, wherein the edge of the separator plate in the region of the shock absorber arrangement extends upwards at a distance from the flat surface plane so that the shock absorber arrangement projects upwards out of the flat surface plane. The shock absorber arrangement projects further out of the flat surface plane than the bead arrangement in a non-compressed state of the assembly.

In this variant, too, the shock absorber arrangement projects beyond the bead arrangement by at least 0.05 and/or at most 0.5 mm, at least 0.08 and/or at most 0.4 mm, and/or at least 0.1 and/or at most 0.3 mm.

The MEA and the separator plate are often arranged one on top of the other, with the border of the MEA projecting beyond the edge of the separator plate in order to avoid short circuits. For example, the shock absorber arrangement may be part of the MEA and/or the separator plate. The MEA may typically contain at least one membrane, for example an electrolyte membrane. Furthermore, a gas diffusion layer (GDL) may be arranged on one or both surfaces of the MEA, The MEA may also have a frame-like reinforcing layer, which frames the electrolyte membrane and reinforces it in the area of overlap with the actual membrane. If the shock absorber arrangement is also part of the MEA, then in the region of the shock absorber arrangement the separator plate need not necessarily project further out of the flat surface plane of the separator plate than the bead arrangement in the non-compressed state in order to still provide the desired shock absorber properties of the assembly. It is possible to compensate for differences in height between the shock absorber arrangement and the bead arrangement by, for example, configuring the regions of the MEA that bear against the shock absorber arrangement in such a way that the shock absorber arrangement is pretensioned when the bead arrangement bears against the MEA and the assembly is compressed. By way of example, shock absorber coatings and/or shock absorber elements, which can absorb impact energy in a manner analogous to the shock absorber arrangements described above, may be arranged in the region of the frame-like reinforcing layer of the MEA. The shock absorber elements or coatings of the MEA may rest on the above-mentioned plateau portion of the separator plate.

Also proposed is a bipolar plate, comprising two separator plates of the type described above, which are connected to each other and are arranged in such a way that the undersides thereof face towards each other and the bead arrangements and shock absorber arrangements of the two separator plates point away from each other. The flat surface planes of the two separator plates are usually oriented parallel to each other. The separator plates may be substantially structurally identical or may differ from each other. In some embodiments, it may be provided that the embodiments of the two separator plates differ from each other. By way of example, the separator plates may differ in the design of the shock absorber arrangements. In a non-compressed state of the bipolar plate, at least one of the shock absorber arrangements of the two separator plates projects further out of the flat surface plane of the separator plate than the bead arrangement of the same separator plate.

In some embodiments of the bipolar plate, an additional shock absorber element may be arranged in a volume spanned between two shock absorber arrangements located opposite each other and pointing away from each other, wherein the two shock absorber arrangements may be in contact with the shock absorber element. The shock absorber element may be deformable and/or elastic. In optional embodiments, the shock absorber element may be able to be inserted into the volume from outside the bipolar plate and/or may be designed as a pad. In some embodiments, such a shock absorber element may be provided in addition to an absorber coating. Furthermore, instead of individual shock absorber elements, it is possible to provide for example one coherent shock absorber element for several such volumes, for example by spraying it on from the side, in a manner comparable to the way in which construction foam is applied. The shock absorber elements may be designed similarly to the supporting elements proposed in the document WO 2019/076813 A1, with WO 2019/076813 A1 being fully incorporated by way of reference in the present specification.

Also proposed is an electrochemical cell which comprises a first separator plate, a second separator plate and a membrane electrode assembly, MEA. The separator plates may be designed in the manner described above. The separator plates are oriented in such a way that the bead arrangement of the first separator plate points towards the bead arrangement of the second separator plate, and the shock absorber arrangement of the first separator plate points towards the shock absorber arrangement of the second separator plate. The MEA is arranged between the separator plates in such a way that at least the bead arrangements bear against the MEA, for example against a frame-like reinforcing border of the MEA, on both sides. The separator plates and the MEA are compressed together so that the bead arrangements seal off the region to be sealed off, around which they extend at least in part, and the shock absorber arrangements are pretensioned against each other by being deflected out of their respective starting position. The cell may comprise the assembly described above, comprising the separator plate and the MEA.

The compressed state is characterized in that mechanical compression forces are exerted on the separator plate, which may deform the separator plate in some regions, such as in the region of the bead arrangements and shock absorber arrangements. Typically, the forces act in a direction perpendicular to the flat surface plane. Optionally, in a compressed state, the forces may act on the regions of the separator plate that project furthest out of the flat surface plane.

A stack of electrochemical cells comprises bipolar plates and membrane electrode assemblies arranged one next to the other or one on top of the other in an alternating fashion, so that a membrane electrode assembly is arranged between two bipolar plates. Structurally rigid and dimensionally stable end plates are usually applied to the ends of the stack in the stacking direction. Once such a stack has been assembled, the components are compressed together in the stacking direction by way of the end plates. The stacking direction is perpendicular to the flat surface planes of the separator plates. One of the aims of the compression is to ensure that the bead arrangements of the bipolar plates bear against the membrane electrode assemblies, so that sealing can take place between the bipolar plates and the membrane electrode assembly. Since the shock absorber arrangement of the separator plates described here projects further out of the flat surface plane than the bead arrangement, the shock absorber arrangement will be deflected out of its starting position before sealing can be achieved by the bead arrangement. Such a pretensioned shock absorber arrangement can therefore have a significant influence on the compression behaviour of the stack as a whole.

In some embodiments, the electrochemical cell may have a first compartment containing a gas enclosed therein. The enclosed gas may be ambient air. The first compartment may be bounded by the shock absorber arrangement of one of the two separator plates, a bead arrangement of this separator plate, a region of this separator plate that extends between the shock absorber arrangement and the head arrangement, and a region of the MEA that extends between the shock absorber arrangement and the bead arrangement.

Should the electrochemical cell be exposed to a force impact, some of the impact energy can be destroyed by the compartment containing the enclosed gas. Deformation of the separator plates often leads to deformation of the compartment. This may lead to gas flowing out of the deformed compartment. Interruptions in the shock absorber arrangement along the circumference of the edge can be used tor this purpose. As the separator plates return to their starting positions, the gas can then flow back into the compartment.

Exemplary embodiments of the separator plate, of the bipolar plate, of the assembly, of the electrochemical cell and of the electrochemical system are shown in the accompanying figures and will be explained in greater detail on the basis of the following description.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 schematically shows, in a perspective view, an electrochemical system comprising a plurality of separator plates or bipolar plates arranged in a stack.

FIG. 2 schematically shows, in a perspective view, two bipolar plates of the system according to FIG. 1, each consisting of two separator plates, with a membrane electrode assembly (MEA) arranged between the bipolar plates.

FIG. 3A schematically shows a perspective view of part of a bipolar plate consisting of two separator plates, in one variation.

FIG. 3B schematically shows a perspective view of part of a bipolar plate consisting of two separator plates, in a further variation.

FIG. 3C schematically shows, in a plan view, part of a separator plate in a further variation.

FIG. 4A schematically shows a sectional view of part of a non-compressed bipolar plate consisting of two separator plates, in a variation with a membrane electrode assembly.

FIG. 4B schematically shows a sectional view of part of a compressed bipolar plate consisting of two separator plates, in a variation with a membrane electrode assembly.

FIG. 5 schematically shows a sectional view of part of a non-compressed bipolar plate consisting of two separator plates, in a further variation with a membrane electrode assembly.

FIG. 6 schematically shows a sectional view of part of a non-compressed bipolar plate consisting of two separator plates, in a further variation.

FIG. 7 schematically shows a sectional view of part of a non-compressed bipolar plate consisting of two separator plates, in a further variation.

FIG. 8 schematically shows a sectional view of part of a non-compressed bipolar plate consisting of two separator plates, in a further variation.

FIG. 9A schematically shows, in a plan view, part of a bipolar plate or separator plate in a further variation,

FIG. 9B shows a sectional view of the bipolar plate of FIG. 9A consisting of two separator plates, along the section line B-B therein.

FIG. 10 schematically shows, in each of sub-FIGS. 10A and 10B, a sectional view of part of a non-compressed bipolar plate consisting of two separator plates, in a further variation.

FIG. 11 shows in sub-FIG. 11A a schematic plan view and in each of sub-FIGS. 11B and 11C a schematic sectional view, along the section lines C-C and D-D, of part of sub-FIG. 11A showing a non-compressed bipolar plate consisting of two separator plates, in a further variation.

### DETAILED DESCRIPTION

Here and below, features that recur in different figures are denoted in each case by the same or similar reference signs. For the sake of clarity, the repetition of reference signs in the figures is sometimes omitted.

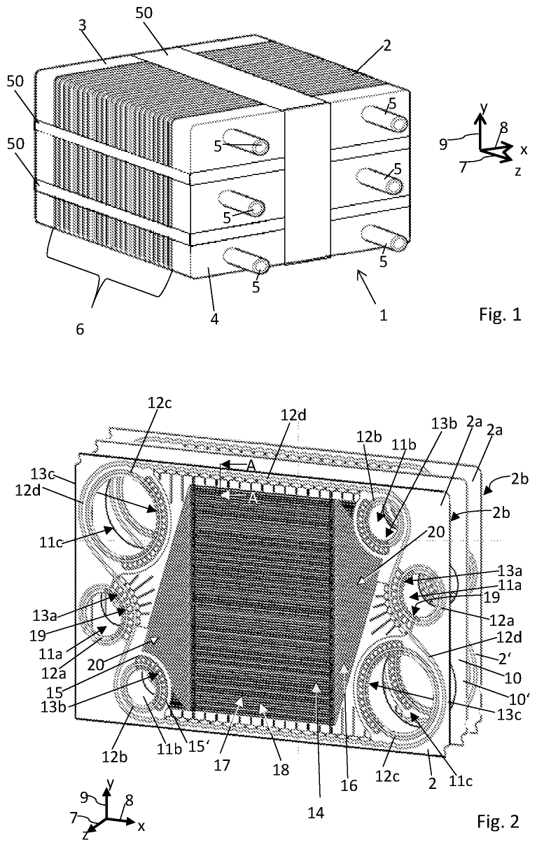

FIG. 1 shows an electrochemical system 1 comprising a plurality of structurally identical metal bipolar plates 2, which are arranged in a stack 6 and are stacked along a z-direction 7. The bipolar plates 2 of the stack 6 are clamped between two end plates 3, 4. Clamping may take place, for example, by way of straps 50 or tie-rods or tension plates (not shown). A closure mechanism of the straps may be arranged on the end plate 3 and is not visible in the view shown. The z-direction 7 is also referred to as the stacking direction. In the present example, the system 1 is a fuel cell stack. Each two adjacent bipolar plates 2 of the stack thus bound an electrochemical cell, which serves for example to convert chemical energy into electrical energy. To form the electrochemical cells of the system 1, a membrane electrode assembly (MEA) 10 is arranged in each case between adjacent bipolar plates 2 of the stack (see, for example, FIG. 2). Each MEA 10 typically contains at least one membrane, for example an electrolyte membrane. The MEA 10 often additionally comprises a frame-like reinforcing layer, which frames the electrolyte membrane and reinforces it in the area of overlap with the actual electrolyte membrane. The reinforcing layer is usually electrically insulating and prevents a short-circuit from occurring during operation of the electrochemical system 1.

In alternative embodiments, the system 1 may also be designed as an electrolyser, as an electrochemical compressor, or as a redox flow battery. Separator plates can be used in these electrochemical systems. The structure of these separator plates may then correspond to the structure of the separator plates 2a, 2b of the bipolar plates 2 that are explained in detail here, although the media guided on and/or through the separator plates in the case of an electrolyser, an electrochemical compressor or a redox flow battery may differ in each case from the media used for a fuel cell system.

The z-axis 7, together with an x-axis 8 and a y-axis 9, spans a right-handed Cartesian coordinate system. The bipolar plates 2 each define a plate plane, each of the plate planes of the separator plates being oriented parallel to the x-y plane and thus perpendicular to the stacking direction or to the z-axis 7. The end plate 4 usually has a plurality of media ports 5, via which media can be supplied to the system 1 and via which media can be discharged from the system 1. Said media that can be supplied to the system 1 and discharged from the system 1 may comprise for example fuels such as molecular hydrogen or methanol, reaction gases such as air or oxygen, reaction products such as water vapour or depleted fuels, or coolants such as water and/or glycol.

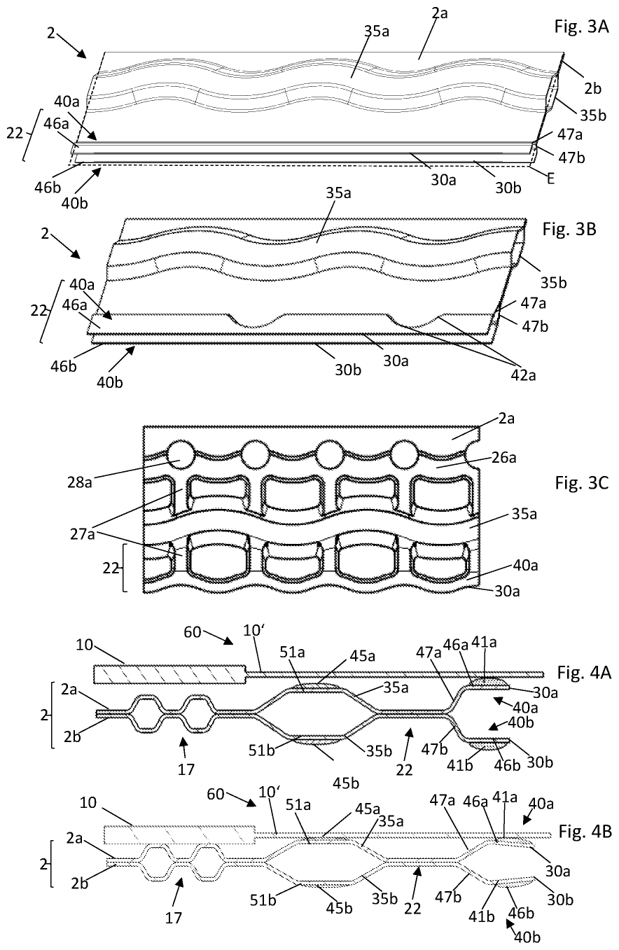

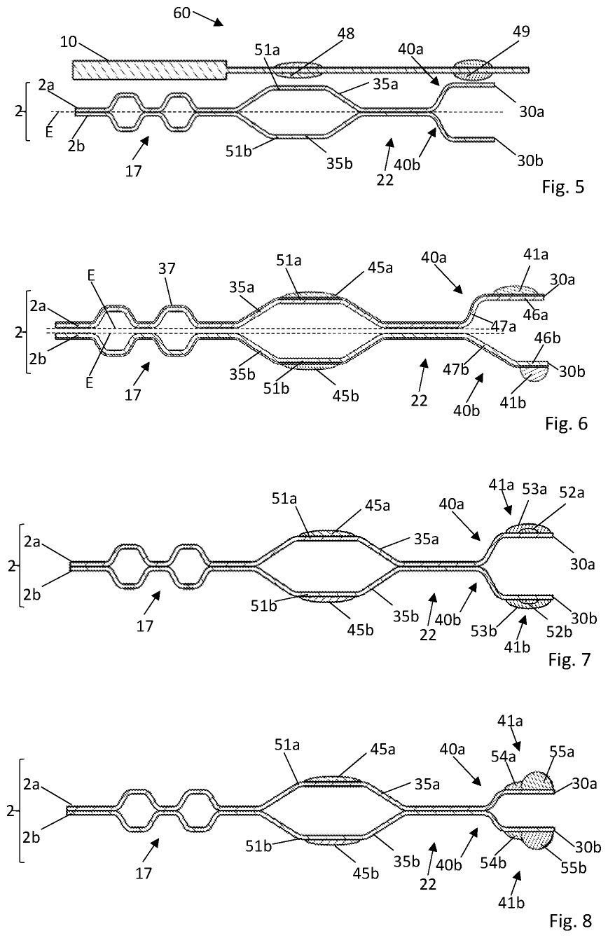

Both conventional bipolar plates 2, as shown in FIG. 2, and assemblies according to the present disclosure, as shown in FIGS. 4A, 4B and 5, or bipolar plates according to the present disclosure, as shown in FIGS. 3A, 3B, 3C and FIG. 6 onwards, can be used in an electrochemical system as shown in FIG. 1.

FIG. 2 shows, in a perspective view, two adjacent bipolar plates 2, 2′, known from the prior art, of an electrochemical system of the same type as the system 1 from FIG. 1, as well as a membrane electrode assembly (MEA) 10 which is arranged between these adjacent bipolar plates 2 and is likewise known from the prior art, the MEA 10 in FIG. 2 being largely obscured by the bipolar plate 2 facing towards the viewer. The bipolar plate 2 is formed of two separator plates 2a, 2b which are joined together in a materially bonded manner (see also, for example, FIGS. 3 to 11C), of which only the first separator plate 2a facing towards the viewer is visible in FIG. 2, said first separator plate obscuring the second separator plate 2b. The separator plates 2a, 2b may each be manufactured from a metal sheet, for example from an optionally (pre-)coated stainless steel sheet. The separator plates 2a, 2b may for example be welded to each other along their outer edge, for example by laser-welded joints.

The separator plates 2a, 2b typically have through-openings, which are aligned with each other and form through-openings 11a-c of the bipolar plate 2. When a plurality of bipolar plates of the same type as the bipolar plate 2 are stacked, the through-openings 11a-c form lines which extend through the stack 6 in the stacking direction 7 ((see FIG. 1). Typically, each of the lines formed by the through-openings 11a-c is fluidically connected to one of the media ports 5 in the end plate 4 of the system 1. For example, coolant can be introduced into the stack 6 via the lines formed by the through-openings 11a, while the coolant can be discharged from the stack 6 via other through-openings 11a. In contrast, the lines formed by the through-openings 11b, 11c may be designed to supply fuel and reaction gas to the electrochemical cells of the fuel cell stack 6 of the system 1 and to discharge the reaction products from the stack 6. The media-guiding through-openings 11a-c are substantially parallel to the plate plane.

In order to seal off the through-openings 11a-c with respect to the interior of the stack 6 and with respect to the surrounding environment, the first separator plates 2a may each have sealing arrangements in the form of port beads 12a-c, which are arranged in each case around the through-openings 11a-c and in each case completely surround the through-openings 11a-c. On the rear side of the bipolar plate 2, facing away from the viewer of FIG. 2, the second separator plates 2b have corresponding port beads for sealing off the through-openings 1a-c (not shown). In cross-section, each bead arrangement of a port bead 12a-12c may have at least one bead top and two bead flanks, but a substantially angular arrangement between these elements is not necessary; a curved transition may also be provided, e.g. beads which are arcuate in cross-section are also possible.

In an electrochemically active region 18, the first separator plates 2a have, on the front side thereof facing towards the viewer of FIG. 2, a flow field 17 with first structures 14 for guiding a reaction medium along the outer side (or also front side) of the separator plate 2a. In FIG. 2, these first structures 14 are defined by a plurality of webs and by channels extending between the webs and delimited by the webs. On the front side of the bipolar plates 2, facing towards the viewer of FIG. 2, the first separator plate 2a additionally has a distribution and collection region 20. The distribution and collection regions 20 comprise second structures 16 for guiding a reaction medium along the outer side (or also front side) of the separator plate 2a, these second structures being designed to distribute over the active region 18 a medium that is introduced from a first of the two through-openings 11b into the adjoining distribution region 20 and to collect or to pool a medium flowing towards the second of the through-openings 11b from the active region 18. In FIG. 2, the second structures 16, e.g. the structures of the distribution and collection region 20, are likewise defined by webs and by channels extending between the webs and delimited by the webs.

The port beads 12a-12c are crossed by conveying channels 13a-13c, which are in each case integrally formed in all the separator plates 2a, 2b, and of which the conveying channels 13a are formed both on the underside of the upper separator plate 2a and on the upper side of the lower separator plate 2b and form a connection between the through-opening 11a and the distribution region 20. By way of example, the conveying channels 13a enable coolant to pass between the through-opening 11a and the distribution and collection region 20, so that the coolant enters the distribution and collection region 20 between the separator plates 2a, 2b and is guided out therefrom.

The conveying channels 13b in the upper separator plate 2a and the conveying channels 13c in the lower separator plate 2b establish, together with apertures 15′ in the flanks of a connecting channel 15 connecting all the conveying channels 13b and 13c, a corresponding connection between the through-opening 11b or 11c and the respective adjoining distribution or collection region 20. For instance, the conveying channels 13b enable hydrogen to pass between the through-openings 12b and the adjoining distribution or collection region on the upper side of the upper separator plate 2a. These conveying channels 13b adjoin apertures 15′—here in the flanks of the connecting channel 15—which face towards the distribution or collection region and which extend at an angle to the plate plane, through which apertures the hydrogen can flow. Conveying channels 13c, together with apertures 15′ in the flanks of the connecting channel 15, enable air, for example, to pass between the through-opening 12c and the distribution or collection region on the rear side of the bipolar plate 2, so that air enters the distribution or collection region on the underside of the lower separator plate 2b and is guided out therefrom (not visible in FIG. 2). Possible further embodiments are disclosed, for example, in the above-mentioned documents DE 20 2022 101 861 and DE 102 48 531 A1.

The first separator plates 2a each also have a further sealing arrangement in the form of a perimeter bead 12d, which extends around the flow field 17 of the active region 18 and also around the distribution or collection regions 20 and the through-openings 11b, 11c and seals these off with respect to the environment surrounding the system 1 and, together with the port beads 12a, with respect to the through-openings 11a, e.g. with respect to the coolant circuit. The second separator plates 2b each comprise corresponding perimeter beads 12d. The structures of the active region 18, the distributing or collecting structures of the distribution or collection region 20 and the sealing beads 12a-d are each formed in one piece with the separator plates 2a and are integrally formed in the separator plates 2a, for example in an embossing, hydroforming or deep-drawing process. The same applies to the corresponding flow fields, distributing structures and sealing beads of the second individual plates 2b.

While the port beads 12a-12c have a substantially round course, which nevertheless depends primarily on the shape of the associated through-opening 11a-11c, the perimeter bead 12d has various sections that are shaped differently. For instance, the course of the perimeter bead 12d may include at least two wavy portions, and port beads 12a-12c may also extend at least in part in a wavy manner.

As mentioned above, the present disclosure has been designed to protect separator plates compressed in a stack, and the bead arrangements 12a-12d thereof, against deformation in the event of a crash. For this purpose, additional structures—namely shock absorber arrangements—are provided, which make it possible to absorb the impact energy. In the subsequent FIGS. 3-11C, the sealing beads are shown as having, in cross-section, at least one bead top and two straight bead flanks, but a substantially angular arrangement between these elements is not necessary; a curved transition may also be provided, e.g. beads which are arcuate in cross-section or bead shapes with a superimposition of wavy structures are also possible, as shown in DE 10 2009 012 730 A1, DE 10 2009 006 413 A1 or DE 20 2014 004 456 U1.

FIGS. 3-11C show various embodiments of the present disclosure. The head arrangements 35a, 35b shown here can be designed and used analogously to the aforementioned conventional bead arrangements 12a-12d of the examples mentioned above.

FIG. 3A shows part of a bipolar plate 2 which comprises two separator plates 2a, 2b. Each of the separator plates 2a, 2b has a bead arrangement 35a, 35b, these bead arrangements pointing away from each other. FIG. 3A also shows edges 30a, 30b which bound the separator plates 2a, 2b laterally in a direction parallel to a corresponding flat surface plane E. If the bead arrangements 35a, 35b form a perimeter bead 12d, the edge 30a, 30b may be an outer edge bounding an outer circumference of the separator plate 2a, 2b; alternatively, if the bead arrangements 35a, 35b form a port bead 12a-c, said edge may be a port edge bounding a through-opening formed in the separator plate 2a, 2b for the passage of a fluid. The bead arrangement 35a, 35b extends at a distance from the edge 30a, 30b at least in part around a region to be sealed off and projects upwards out of the flat surface plane.

Shock absorber arrangements 40a, 40b are also shown. The shock absorber arrangements 40a, 40b are arranged at least in part along the edges 30a, 30b and extend upwards at a distance from the flat surface plane E. The shock absorber arrangements 40a, 40b thus in each case project upwards out of the corresponding flat surface plane if the respective flat surface plane of the separator plate 2a, 2b is considered to be “at the bottom”. The shock absorber arrangements 40a, 40b are arranged at a distance from the head arrangement 35a, 35b in the x-y direction. Enclosed between the edge 30a, 30b and the bead arrangement 35a, 35b is a region which will hereinafter also be referred to as the outer border region 22. The outer border region 22 has, in the region of the shock absorber arrangement 40a, 40b, a substantially flat plateau portion 46a, 46b and a flank 47a, 47h or curvature rising at an angle out of the flat surface plane, the flank 47a, 47h or curvature typically merging into the plateau portion 46a, 46b. In the region of the plateau portion 46a, 46b, the shock absorber arrangement 40a, 40h is formed at least in part parallel to the flat surface plane.

The shock absorber arrangements 40a, 40b and the bead arrangements 35a, 35b of the separator plates 2a, 2b are each formed in one piece with the separator plates 2a, 2b and are integrally formed in the respective separator plates 2a, 2h, for example in an embossing, deep-drawing or hydroforming process.

In FIG. 3A, the flat surface plane E may be defined by in each case three points in the undeformed regions of the respective separator plate 2a, 2b and extends substantially parallel to a plane spanned by the x-direction 8 and the y-direction 9. It is shown here at the interface between the two separator plates 2a, 2b. Undeformed regions may therefore be, for example, the flat regions of the separator plate which are arranged between the shock absorber arrangement 40a, 40b and the bead arrangement 35a, 35b. The shock absorber arrangements 40a, 40b project further out of the respective flat surface plane than the bead arrangements 35a, 35b. In the present example, the distance by which they project beyond the latter in the non-compressed state is 0.15 mm, e.g. twice as large as the sheet thickness of 0.075 mm used here.

In projection onto the flat surface plane of the respective separator plate 2a, 2b, the course of the edge 30a, 30b is straight. Also, the width of the shock absorber arrangement 40a, 40b is constant along the course of the edge and does not vary. The bead arrangement 35a, 35b is arranged at a distance from the edge 30a, 30b. The distance of the bead arrangement 35a, 35b from the edge 30a, 30b is not constant along the course of the bead arrangement 35a, 35h, but instead varies along the course repeatedly between a minimum distance and a maximum distance, resulting in a wavy course of the bead arrangement.

Embodiments are also possible in which the distance between the bead arrangement 35a, 35b and the edge 30a, 30b is at least in part constant along the course of the bead arrangement 35a, 35b. Embodiments are also possible in which the width of the bead arrangement 35a, 35b, e.g. the extent thereof in a direction perpendicular to the course thereof, varies along the course of the bead arrangement 35a, 35b. In the embodiment shown in this figure, the shock absorber arrangement 40a, 40b, and also the edge 30a, 30b in the region of the shock absorber arrangement 40a, 40b, extends at least in part parallel to the respective flat surface plant.

Like FIG. 3A, FIG. 3B shows part of a bipolar plate 2 comprising two separator plates 2a, 2b. In contrast to the embodiment shown in FIG. 3A, the width of the shock absorber arrangement 40a, 40b and thus also the width of the plateau portion 46a, 46b varies along the course of the shock absorber arrangement 40a, 40b as a result of stiffening structures 42a being provided, which stiffen the shock absorber arrangement 40a, 40b. In the region of the stiffening structures 42a, the shock absorber arrangement 40a, 40b has a reduced width, which varies along the course of a stiffening structure 42a. Between the regions of reduced width, the width of the shock absorber arrangement 40a, 40b is constant along the course of the shock absorber arrangement 40a, 40b. Embodiments are also possible in which the height of the shock absorber arrangement 40a, 40b, that is to say the distance of the shock absorber arrangement 40a, 40b from the flat surface plane in a non-compressed state, varies along the course of the shock absorber arrangement.

These stiffening structures 42a make it possible to stiffen the edge of the separator plates so that undesirable deformations in this region can be prevented. The stiffening structures may serve the same purpose as the stiffening structures proposed in the document DE 10 2021 212 053 A1, with DE 10 2021 212 053 A1 being fully incorporated by way of reference in the present specification.

FIG. 3C shows an embodiment of a separator plate 2a in a port region, that is to say in the region of one of its through-openings 11a-c, in plan view. The course of the edge is not straight in projection onto the flat surface plane, but instead is wavy. The edge 30a bounds a port region which is sealed off by the bead arrangement 35a. The shock absorber arrangement 40a extends along the edge 30a and has a constant width along its course. Furthermore, the separator plate 2a in this embodiment has conveying channels 27a, as well as apertures 28a, so that a fluid can be conveyed from the through-opening, through the bead arrangement 35a, to the electrochemically active region 18, or vice versa. The fluid can enter the conveying channel 27a in the region of the edge 30a and can exit from the conveying opening 28a located on the other side of the bead arrangement 35a. The conveying channels 27a start from the edge 30a in a perpendicular direction, pass through the bead arrangement 35a, and end in the conveying openings 28a. The conveying openings 28a form an opening or a hole in the separator plate 2a. The conveying channels 27a are arranged at the locations on the edge 30a at which the edge 30a has the deepest indentation. At the ends at which the conveying openings 28a are arranged, adjacent conveying channels 27a are connected to each other by the connecting channel 26a.

FIGS. 4A and 4B show a sectional view of an assembly 60 for an electrochemical system 1, comprising a bipolar plate 2 and an adjacent membrane electrode assembly 10 which are arranged one on top of the other, wherein the membrane electrode assembly 10 projects beyond the bipolar plate, more specifically beyond the edges 30a, 30b thereof. The bipolar plate 2 comprises two separator plates 2a, 2b which are connected to each other, such as in a materially bonded manner. The sectional plane is both perpendicular to the flat surface plane and perpendicular to the course of the edges of the separator plates 2a, 2b.

FIG. 4A shows the bipolar plate and the MEA 10 in a non-compressed state. This means that no mechanical force is being exerted on the bipolar plate 2 and the MEA 10. FIG. 4B shows the bipolar plate 2 in a compressed state, as in a compressed plate stack according to FIG. 1. In the compressed state, the MEA 10 is pushed in the direction of the flat surface plane. A mechanical tensioning force acts on the bipolar plate 2 and the MEA 10. In the example shown, the mechanical force acts on both sides in a direction perpendicular to the flat surface plane and deflects for example the shock absorber arrangement 40a, 40h out of its starting position.

The assembly 60 shown in FIGS. 4A and 4B has a bipolar plate 2 comprising two separator plates 2a, 2b, which are arranged in such a way that the undersides thereof face towards each other and the bead arrangements 35a, 35h and the shock absorber arrangements 40a, 40b of the two separator plates point away from each other. The flat surface planes of the separator plates 2a, 2b are oriented parallel to each other. Each of the separator plates 2a, 2h has a bead arrangement 35a, 35b and a shock absorber arrangement 40a, 40b. The shock absorber arrangement 40a, 40b has a deformable absorber coating 41a, 41h which projects further out of the flat surface plane than the bead arrangement 35a, 35b in a non-compressed state of the separator plate 2a, 2b.

It can be seen in the sectional view that, in the region of the shock absorber arrangement 40a, 40b, the outer border region has the substantially flat plateau portion 46a, 46b and the flank 47a, 47b or curvature rising at an angle out of the flat surface plane, the flank 47a, 47b or curvature typically merging into the plateau portion 46a, 46b. The sheet layer of the separator plates 2a, 2b in the region of the shock absorber arrangement projects further out of the flat surface plane, by approximately one sheet thickness, here 0.1 mm, than the sheet material in the region of the bead arrangement 35a, 35b. The shock absorber arrangement 40a, 40b is thus formed at least in part parallel to the flat surface plane. In the embodiment shown, the absorber coating 41a, 41b forms the region of the separator plate 2a, 2b that projects furthest upwards out of the flat surface plane. Here, the absorber coating 41a, 41h is approximately twice as thick as the sealing coating 45a, 45b. Embodiments are also conceivable in which the absorber coating 41a, 41b does not form, or forms only in part, the region of the separator plate 2a, 2b that projects furthest upwards out of the flat surface plane.

The bead arrangement 35a, 35b has a sealing coating 45a, 45b which projects less far out of the flat surface plane than the shock absorber arrangement 40a, 40b in a non-compressed state of the separator plate 2a, 2b. In the illustrated view of the separator plate, the sealing coating 45a, 45b is arranged in a region of the bead arrangement 35a, 35b that is substantially parallel to the flat surface plane of the separator plate 2a, 2b. Such a region will hereinafter also be referred to as the head top 51a, 51b. The separator plates 2a, 2b also have flow fields 17, which in the compressed state of the bipolar plate 2 can be sealed off by the respective bead arrangement 35a, 35h.

The absorber coating 41a, 41h may comprise or consist of a polymer. The sealing coating 45a, 45b may comprise or consist of a polymer. Due to their different functions, the sealing coating 45a, 45h and the absorber coating 41a, 41h may comprise different materials or consist of different materials; for example, the absorber coating 41a, 41b may have a higher elasticity than the sealing coating 45a, 45h. For instance, the absorber coating 41a, 41b absorbs at least some of the energy resulting from an impact and is capable of destroying or dissipating this energy internally. Open-pored foam materials may work well for this purpose. In alternative embodiments, the materials of the absorber coating 41a, 41b and of the sealing coating 45a, 45b are the same.

In the non-compressed state, which is shown in FIG. 4A, the shock absorber arrangement 40a is in contact with a reinforcing border 10′ of the membrane electrode assembly 10. The reinforcing border 10′ of the MEA 10 may be formed, for example, by a frame or the frame-like reinforcing layer and is usually electrically insulating, as already described in connection with FIG. 2. In the illustrated embodiment of the MEA, the reinforcing border 10′ is formed by the region of the MEA that has a reduced thickness. The shock absorber arrangement 40a, 40h is shown in its starting position, with no force being applied. Since the membrane electrode assembly is oriented parallel to the flat surface planes of the separator plates and the shock absorber arrangement 40a, 40b projects further out of the flat surface plane than the bead arrangement 35a, 35b, the bead arrangement 35a, 35b, in the abstract view shown, does not touch the membrane electrode assembly 10 in the non-compressed state. In practice, however, the MEA 10 is often flexible and therefore touches the bead arrangement 35a even in a non-compressed state of the assembly 60. When force is applied, the shock absorber arrangement 40a, 40b can be deflected out of its starting position. As a result, the shock absorber arrangement 40a, 40b can be pretensioned. In the view shown, the bead arrangement 35a, 35b only bears against the membrane electrode assembly 10 when the shock absorber arrangement 40a, 40h is pretensioned.

FIG. 4B shows a sectional view of the bipolar plate 2 in a compressed state of the assembly 60. The shock absorber arrangement 40a, 40h is pretensioned and the bead arrangement 35a, 35h is bearing against the membrane electrode assembly 10. By clamping the end plates 3 and 4, for example by means of the straps 50 in FIG. 1, a force acts on the bipolar plate 2 and the MEA 10 in the direction of compression.

The sectional views of FIGS. 4A and 4B, as well as the subsequent sectional views, for which no further indication of their position is given, may be arranged for example in a region corresponding to the section A-A in FIG. 2; the edge 30a, 30b may therefore be, for example, an outer edge. However, it could also be an inner edge—similar to what is shown in figure group 11.

FIG. 5 shows a sectional view of a further embodiment of separator plates 2a, 2b with a membrane electrode assembly in a non-compressed state of the assembly 60, in a slightly exploded view. In this embodiment, the shock absorber arrangement 40a, 40b again projects further upwards out of the flat surface plane than the bead arrangement 35a, 35b; the projection of the sheet in the region of the shock absorber arrangement 40a, 40b is already approximately one sheet thickness greater than that of the sheet of the bead arrangement. In this embodiment, the sealing elements 48 and the absorber elements 49 are not arranged on the bead tops 51a, 51b of the bead arrangements 35a, 35b and on the plateau portions 46a, 46b of the separator plates 2a, 2b; instead, they are integrally formed on the reinforcing border 10′ of the MEA 10 or are applied to the reinforcing border 10′ of the MEA 10, for example in a coating process or by adhesive bonding. In the view shown in FIG. 5, the shock absorber arrangement is formed of the plateau portions 46a, 46b and of the absorber element 49 of the MEA 10. The absorber elements 49 are approximately 1.5 times as high as the sealing coatings 48. Embodiments are also possible in which only a sealing coating is arranged on the bead arrangement 35a, 35b or only an absorber coating is arranged on the plateau portion 46a, 46b, with the respective other coating being arranged on the MEA. FIG. 5 therefore shows an assembly 60 comprising a separator plate 2a, 2b and a membrane electrode assembly 10, wherein the separator plate 2a, 2b has at least one bead arrangement 35a, 35b and at least one shock absorber arrangement 40a, 40b.

The assembly 60 of FIG. 5 is shown in a non-compressed state. In the state shown, no mechanical force is being exerted on the separator plate 2a, 2b and the MEA 10. In a compressed state, a force acts on the bipolar plate 2 and the MEA 10 in the direction of compression by clamping the end plates 3 and 4, for example by means of straps 50. As a result, the plateau portion 46a, 46b and/or the absorber element 49 are deflected out of their starting position. The shock absorber arrangement 40a, 40b is therefore pretensioned in such a compressed state.

FIG. 6 shows a sectional view of two separator plates 2a, 2b of further embodiments. On the one hand, unlike in the other embodiments, the two separator plates 2a, 2b have fun-surface coatings 37 on one side for example. Such a coating may be used to prevent corrosion, even on both surfaces of a separator plate.

Here, the two separator plates 2a, 2b have differently designed shock absorber arrangements 40a, 40b, but the latter do have comparable widths. While the shock absorber arrangement 40a has a steep flank 47a and a wide plateau region, the shock absorber arrangement 40b is designed with a much shallower flank 47b and a narrow plateau region 46b. The steeper flank 47a has the consequence that the shock absorber arrangement 40a has a lower elasticity, with regard to its metal component, than the shock absorber arrangement 40b. The absorber coatings 41a, 41b are also designed differently in terms of their geometric shape. If using the same material, this means that the wide, less high absorber coating 41a is harder, that is to say has a greater spring constant, than the narrow, considerably higher absorber coating 41b.

In FIG. 6, the separator plates 2a, 2b are shown at a distance from each other. On the one hand, they can be joined to form a bipolar plate 2, as in the example of FIG. 5, so that the stack then has shock absorbers with different properties in an alternating fashion. On the other hand, the spaced-apart view is also intended to illustrate that they can be separator plates 2a, 2b which are independent of each other. These can be joined, for example, to separator plates which are mirror-symmetrical in the region of the assembly 60 in order to form a bipolar plate 2. In addition, the two sections shown in FIG. 6 may be sections of one and the same separator plate, with the sections being arranged in different portions of the edge. The bead arrangement 35b could therefore be (rotated through 180°) a continuation of the bead arrangement 35a. This is intended to illustrate that the shock absorber arrangements 40a, 40b can be formed differently along their course.

As a supplement to FIG. 3A, FIGS. 5 and 6 illustrate the position of the flat surface plane F of a separator plate and the coincidence of the flat surface planes of the two separator plates, connected to form the bipolar plate, in the plane of contact of these two separator plates.

FIG. 7 shows a sectional view of a bipolar plate 2 comprising two separator plates 2a, 2b according to a further embodiment. The shock absorber arrangement 40a, 40b has an absorber coating 41a, 41b and projects further upwards out of the flat surface plane of the separator plate 2a, 2b than the head arrangement 35a, 35b. The bead arrangement 35a, 35b has a sealing coating 45a, 45b. The absorber coating 41a, 41b comprises a first absorber coating 52a, 52b and a second absorber coating 53a, 53b, with the first absorber coating 52a, 52b being arranged beneath the second absorber coating 53a, 53b. The second absorber coating 53a, 53b has therefore been applied after the first absorber coating 52a, 52b. In this case, the second absorber coating encloses the first absorber coating at least in part. The second absorber coating may comprise the highest point of the separator plate 2a, 2b. The first absorber coating 52a, 52b and the second absorber coating 53a, 53b may comprise different materials. As a result, the first absorber coating 52a, 52b and the second absorber coating 53a, 53b may have different properties, for example different damping or spring properties.

FIG. 8 shows a sectional view of a bipolar plate 2 comprising two separator plates 2a, 2b according to a further embodiment. The shock absorber arrangement 40a, 40h has an absorber coating 41a, 41b and projects further upwards out of the flat surface plane of the separator plate 2a, 2b than the head arrangement 35a, 35b. The bead arrangement 35a, 35h has a sealing coating 45a, 45b. The absorber coating 41a, 41b comprises a first absorber coating 54a, 54h and a second absorber coating 55a, 55b. The first absorber coating 54a, 54b is in this case arranged next to the second absorber coating 55a, 55b. The second absorber coating 55a, 55b projects further out of the flat surface plane than the first absorber coating 54a, 54h. The first absorber coating 54a, 54b and the second absorber coating 55a, 55b may comprise different materials and thus may have different properties, such as different damping or spring properties. In the embodiment shown in FIG. 8, the height of the plateau portion 46a, 46b is lower than the maximum height of the bead arrangement 35a, 35b, even without the bead coating 51a, 51b. Nevertheless, on account of the absorber coating 41a, 41h, the shock absorber arrangement 40a, 40h still projects further upwards out of the flat surface plane than the bead arrangement 35a, 35h.

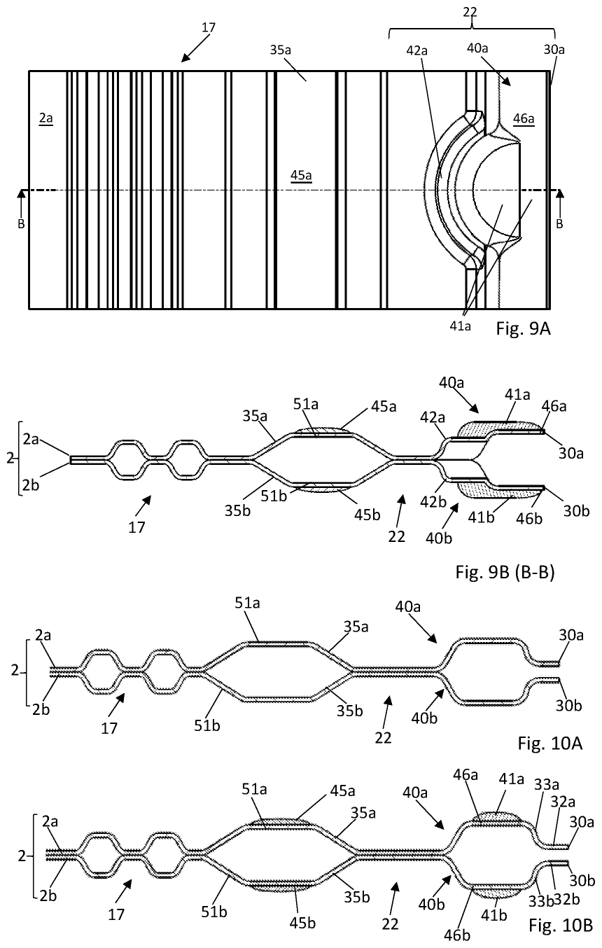

FIGS. 9A and 9B each show a bipolar plate comprising two separator plates 2a, 2h according to a further embodiment. The shock absorber arrangement 40a, 40b in this case additionally has a stiffening structure 42a, 42b, which points away from the edge 30a, 30h and towards the bead arrangement 35a, 35b. The stiffening structure 42a, 42b is designed as a broadening of the shock absorber arrangement 42a, 42h. The stiffening structure 42a, 42b therefore constitutes a bulge, in contrast to the embodiment shown in FIG. 3B in which the stiffening structure 42a, 42b is formed as an indentation in the shock absorber arrangement 40a, 40b. The shock absorber arrangement 40a, 40b has an absorber coating 41a, 41b and projects further upwards out of the flat surface plane of the separator plate 2a, 2b than the bead arrangement 35a, 35b. The absorber coating 41a, 41b is also arranged on the stiffening structure 42a, 42b. The bead arrangement 35a, 35b has a sealing coating 45a, 45b.

FIG. 9A shows a plan view of the bipolar plate 2. The edge 30a has a straight course. The bead arrangement 35a extends parallel to the edge 30a. In a plan view of the separator plate 2a, it can be seen that the stiffening structure 42a is designed as a bulge of the shock absorber arrangement 40a that points towards the bead arrangement 35a. Outside of the region in which the stiffening structure 42a is arranged, the width of the shock absorber arrangement 40a is constant along its course.

In the sectional view of the bipolar plate 2 of FIG. 9A that is shown in FIG. 9B, the design of the stiffening structure 42a, 42b becomes clear. The sectional plane is perpendicular to the flat surface planes of the two separator plates 2a, 2b, extends perpendicular to the edge 30a, 30b, and intersects the stiffening structure 42a, 42b at its widest point. The course of the sectional plane is indicated by the line B-B in FIG. 9A. The stiffening structure 42a, 42b has a plateau that is lower than the associated plateau portion 46a, 46b of the shock absorber arrangement 40a, 40b, The absorber coating 41a, 41b is arranged on the entire region of the shock absorber arrangement 40a, 40b through which the sectional plane extends. The absorber coating 41a, 41b comprises the highest point of the separator plate 2a, 2b.

It may be provided, for example, that stiffening structures with multiple absorber coatings arranged side by side are provided in localized portions, while shock absorber arrangements without any coating are provided in other portions.

FIG. 10 shows, in two variants in sub-FIGS. 10A and 10B, a bipolar plate comprising two separator plates 2a, 2b according to a further embodiment. Adjacent to the edge 30a, 30b, both variants have a bearing portion 32a, 32b, which is connected to the plateau portion 46a, 46b via a further absorber flank 33a, 33b. The bearing portions 32a, 32b serve as a displacement limiting element for each other, so that the respective shock absorber arrangement 40a, 40b can only undergo limited deformation. The bearing portions 32a, 32b are significantly shorter than the height of the respective shock absorber arrangements 40a, 40b so that, when the assembly 60 is compressed, no contact can occur between one of the edges 30a, 30b and the respective nearest MEA. The two sub-FIGS. 10A and 10B differ in that bead coatings and absorber coatings are present only in sub-FIG. 10B. The bipolar plate 2 of FIG. 10A could thus also be combined with an MEA 10, as shown in FIG. 5.

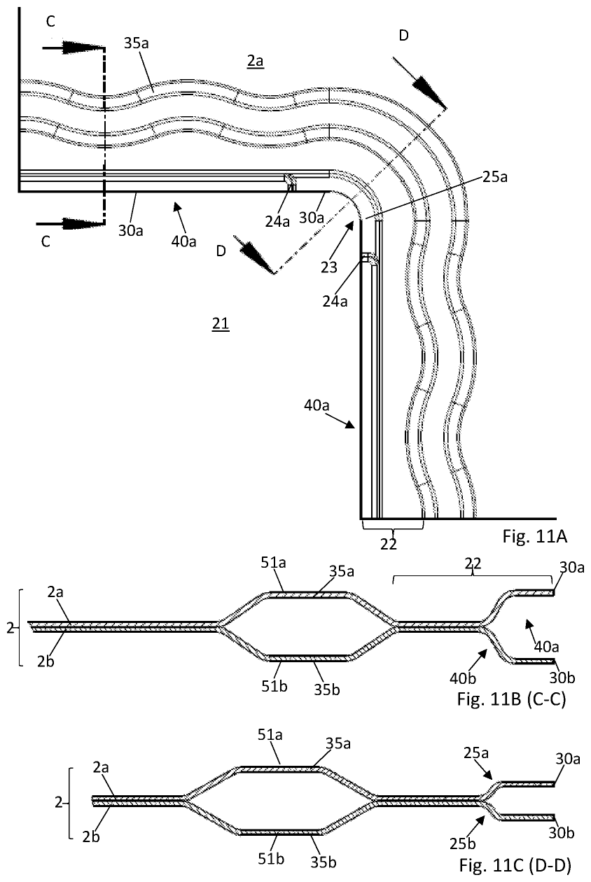

FIG. 11 shows, in a plan view in sub-FIG. 11A, part of a separator plate 2a in the region of a through-opening 21 and the regions adjacent thereto. The shock absorber arrangement 40a is formed only in part along the inner edge 30a. In the corner region 23, which in this case is angular, the shock absorber arrangement 40a is reduced to the height of a supporting element 25a via transitions on both sides 24a. This avoids excessive compression of the corner region 23 and thus avoids damage to the MEA. The different heights of the shock absorber arrangement 40a, 40b and of the supporting element 25a, 25b are shown in sub-FIGS. 11B and 11C, which are sections along the section lines C-C and D-D in sub-FIG. 11A, wherein examples without any bead coating or absorber coating are shown schematically here. The height of the elements 40a, 40h on the one hand and 25a, 25b on the other hand could still be achieved if bead coatings and/or absorber coatings were present, as in some of the preceding embodiments. To distinguish a shock absorber arrangement 40a, 40b from a supporting element 25a, 25b, it is essential that a supporting element 25a, 25b projects less far upwards out of the flat surface plane of the separator plate 2a, 2b than the bead arrangement 35a, 35b of the same separator plate 2a, 2b, while a shock absorber arrangement 40a, 40b projects beyond the associated bead arrangement 35a, 35b.

In principle, in the above-described arrangements of the bipolar plates and separator plates, both the separator plates and individual features of the separator plates can be combined with each other without departing from the scope of protection of the present disclosure. It is also possible that separator plates have certain features only in part.

FIGS. 1-11C are shown approximately to scale. FIGS. 1-11C show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” or “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A separator plate for an electrochemical system, having
at least one edge which bounds the separator plate laterally in a direction parallel to a flat surface plane of the separator plate;
a bead arrangement which extends at a distance from the edge at least in part around a region to be sealed off and projects upwards out of the flat surface plane; and
at least one shock absorber arrangement which is arranged at a distance from the bead arrangement and arranged at least in partially along the edge, wherein the edge in the region of the shock absorber arrangement extends upwards at a distance from the flat surface plane so that the shock absorber arrangement projects upwards out of the flat surface plane, wherein the shock absorber arrangement projects further out of the flat surface plane than the bead arrangement in a non-compressed state of the separator plate.

2. The separator plate according to claim 1, wherein the shock absorber arrangement has a deformable absorber coating which projects further out of the flat surface plane than the bead arrangement in a non-compressed state of the separator plate.

3. The separator plate according to claim 2, wherein the absorber coating forms the region of the separator plate that projects furthest upwards out of the flat surface plane.

4. The separator plate according to claim 2, wherein, in a non-compressed state of the separator plate, the shock absorber arrangement projects further out of the flat surface plane than the bead arrangement by at least 0.05 and/or at most 0.5 mm.

5. The separator plate according to claim 3, wherein the absorber coating comprises or consists of a polymer.

6. The separator plate according to claim 1, wherein the bead arrangement has a sealing coating which protrudes less far out of the flat surface plane than the shock absorber arrangement in a non-compressed state of the separator plate.

7. The separator plate according to claim 6, wherein the sealing coating comprises or consists of a polymer.

8. The separator plate according to claim 2, wherein the sealing coating and the absorber coating comprise or consist of different material compositions.

9. The separator plate according to claim 1, the edge comprising an outer edge which bounds an outer circumference of the separator plate, and/or a port edge which bounds a through-opening formed in the separator plate for the passage of a fluid.

10. The separator plate according to claim 1, wherein the shock absorber arrangement and/or the edge in the region of the shock absorber arrangement extend at least in part parallel to the flat surface plane of the separator plate.

11. The separator plate according to claim 2, wherein the shock absorber arrangement has stiffening structures which point away from the edge and/or point towards the bead arrangement.

12. The separator plate according to claim 11, wherein the absorber coating is arranged on the stiffening structures.

13. The separator plate according to claim 1, wherein supporting arrangements are arranged along part of the edge, which supporting arrangements project less far upwards out of the flat surface plane of the separator plate than the bead arrangement.

14. The separator plate according to claim 1, wherein the width of the shock absorber arrangement and/or the maximum distance of the shock absorber arrangement from the flat surface plane and/or the slope of a flank of the shock absorber arrangement in a non-compressed state varies along the course of the shock absorber arrangement.

15. A bipolar plate, comprising two separator plates according to claim 1, which are connected to each other and are arranged in such a way that the undersides thereof face towards each other and the bead arrangements and shock absorber arrangements of the two separator plates point away from each other.

16. An electrochemical cell, comprising
a first separator plate and a second separator plate according to claim 1 and a membrane electrode assembly, MEA,
wherein the separator plates are oriented in such a way that the bead arrangement of the first separator plate points towards the bead arrangement of the second separator plate, and the shock absorber arrangement of the first separator plate points towards the shock absorber arrangement of the second separator plate,
wherein the MEA is arranged between the separator plates in such a way that at least the bead arrangements bear against the MEA on both sides,
wherein the separator plates and the MEA are compressed together so that the bead arrangements seal off the region to be sealed off, around which the bead arrangements extend at least in part, and the shock absorber arrangements are pre-tensioned against each other by being deflected out of their respective starting position.

17. An assembly for an electrochemical system, comprising a separator plate,
having at least one edge which bounds the separator plate laterally in a direction parallel to the flat surface plane of the separator plate;
having a bead arrangement which extends at a distance from the edge at least in part around a region to be sealed off and projects upwards out of the flat surface plane;
the assembly further comprising a membrane electrode assembly (MEM and a shock absorber arrangement,
wherein the shock absorber arrangement is arranged at least in part along the edge, at a distance from the bead arrangement, and the edge of the separator plate in the region of the shock absorber arrangement extends upwards at a distance from the flat surface plane so that the shock absorber arrangement projects upwards out of the flat surface plane, wherein the shock absorber arrangement projects further out of the flat surface plane than the bead arrangement in a non-compressed state of the assembly.

18. The assembly according to claim 17, wherein, in a non-compressed state of the separator plate, the shock absorber arrangement projects further out of the flat surface plane than the bead arrangement by at least 0.05 and/or at most 0.5 mm.

19. The assembly according to claim 18, wherein the shock absorber arrangement is part of the MEA and/or the separator plate.
